(19) United States
(12) Patent Application Publication
(10) Pub. No.: US 2023/0275302 A1
(43) Pub. Date: Aug. 31, 2023

(54) POWER SUPPLY DEVICE

(71) Applicants: Inventec (Pudong) Technology Corporation, Shanghai (CN); INVENTEC CORPORATION, Taipei (TW)

(72) Inventor: Chi-Cheng HSIAO, Taipei (TW)

(21) Appl. No.: 17/731,303

(22) Filed: Apr. 28, 2022

(30) Foreign Application Priority Data
Feb. 25, 2022 (CN) 202210179556.6

(51) Int. Cl. H01M 50/242; H01M 50/24; H01M 50/249; H01M 50/186; H01M 50/207

(52) U.S. Cl. CPC H01M 50/242; H01M 50/24; H01M 50/249; H01M 50/186; H01M 50/207

(57) ABSTRACT

A power supply device includes a first battery module and a second battery module. The first battery module includes a first casing and a first battery assembly. The first casing has a first accommodation space and a first opening, and the first opening is connected to the first accommodation space. The first battery assembly is fixed in the first accommodation space. The second battery module includes a second casing and a second battery assembly. The second casing has a second accommodation space and a second opening, and the second opening is connected to the second accommodation space. The second battery assembly is fixed in the second accommodation space. The first casing is mounted on the second casing, each of the first casing and the second casing is made of a single piece, and the first casing and the second casing are the same in shape and size.

### CROSS-REFERENCE TO RELATED APPLICATIONS

This non-provisional application claims priority under 35 U.S.C. § 119(a) on Patent Application No(s). 202210179556.6 filed in China, on Feb. 25, 2022, the entire contents of which are hereby incorporated by reference.

### BACKGROUND OF THE INVENTION

### Technical Field of the Invention

The invention relates to a supply device, more particularly to a power supply device.

### Description of the Related Art

In an electric vehicle system, a battery assembly is generally packed into a rigid battery box, such that the battery assembly and the battery box integrate into a battery pack so as to achieve the overall connection and protection effect, and the battery pack has a sufficient structural strength to be fixed on a chassis of the electric vehicle.

However, merely using the battery box to protect the battery assembly is insufficient to meet the waterproof and dustproof requirement during the movement of the vehicle. In other words, the anti-vibration capability of the battery box is insufficient, and thus the battery pack may still suffer from the adverse influences caused by vibration, environment humidity, and dust. Therefore, how to improve the structural strength and the waterproof and dustproof effect of the battery pack is one of the crucial topics in this field.

### SUMMARY OF THE INVENTION

The invention provides a power supply device which is capable of having a sufficient structural strength and a desired waterproof and dustproof effect.

One embodiment of the invention provides a power supply device. The power supply device includes a first battery module and a second battery module. The first battery module includes a first casing and a first battery assembly. The first casing has a first accommodation space and a first opening, and the first opening is connected to the first accommodation space. The first battery assembly is fixed in the first accommodation space. The second battery module includes a second casing and a second battery assembly. The second casing has a second accommodation space and a second opening, and the second opening is connected to the second accommodation space. The second battery assembly is fixed in the second accommodation space. The first casing is mounted on the second casing, each of the first casing and the second casing is made of a single piece, and the first casing and the second casing are the same in shape and size.

According to the power supply device as discussed in the above embodiment, since the first casing of one single piece and the second casing of one single piece are symmetrical with each other and are the same in shape and size, the height of the first casing and the height of the second casing may be approximately equal to a half of the overall height of the power supply device, such that the structure strengths of the first casing and the second casing can be increased, and the first casing and the second casing can achieve the waterproof and dustproof effect of IP67.

In addition, the first battery assembly and the second battery assembly are respectively and symmetrically mounted in the first casing and the second casing, the combination of the first casing and the first battery assembly can increase the overall structural strength of the first battery module, and the combination of the second casing and the second battery assembly can increase the overall structural strength of the second battery module.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a perspective view of a power supply device according to one embodiment of the invention; and

FIG. 2 is an exploded view of the power supply device in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present invention, such as technical and scientific terms, have its own meanings and can be comprehended by those skilled in the art, unless the terms are additionally defined in the present invention. That is, the terms used in the following paragraphs should be read on the meaning commonly used in the related fields and will not be overly explained, unless the terms have a specific meaning in the present invention.

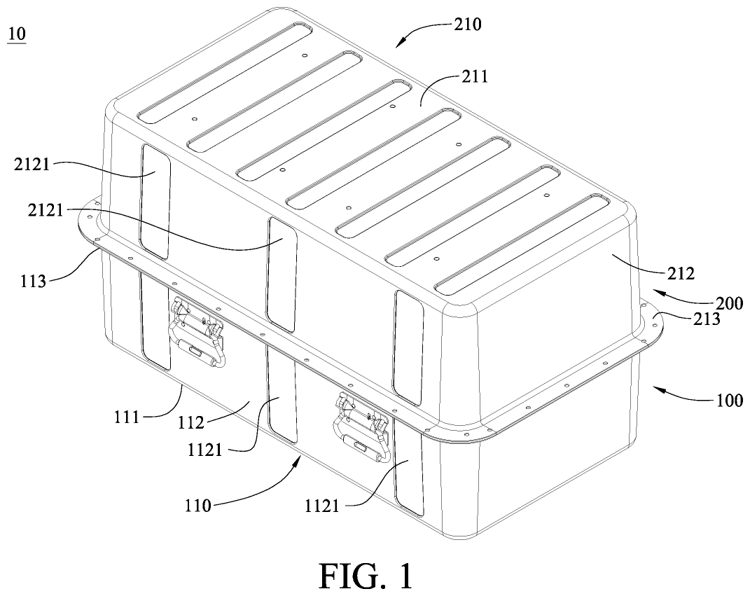

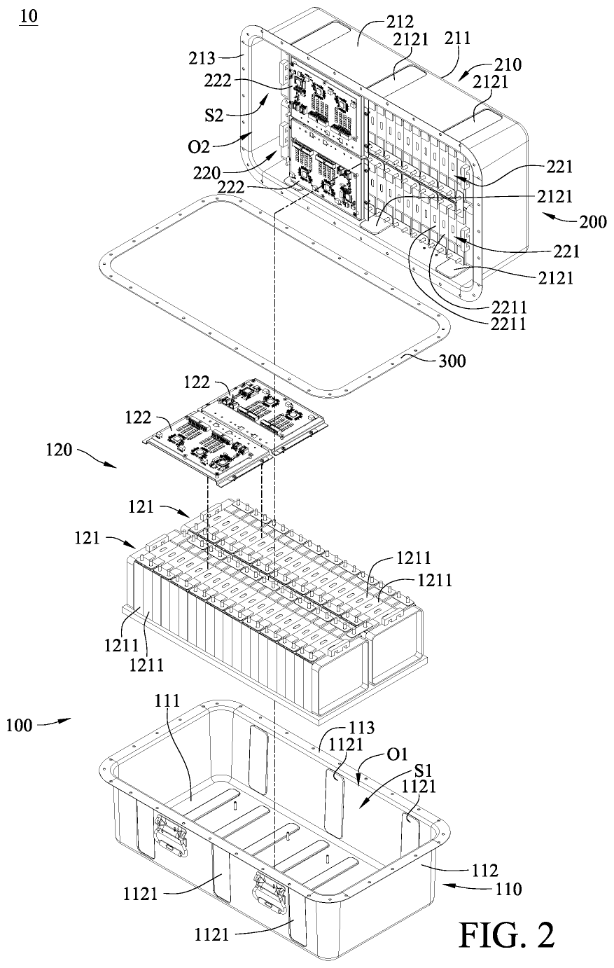

Referring to FIGS. 1 and 2, where FIG. 1 is a perspective view of a power supply device 10 according to one embodiment of the invention, and FIG. 2 is an exploded view of the power supply device 10 in FIG. 1.

In this embodiment, the power supply device 10 is a lithium battery pack of an electric vehicle. The power supply device 10 includes a first battery module 100 and a second battery module 200. The first battery module 100 includes a first casing 110 and a first battery assembly 120. The first casing 110 has a first accommodation space S1 and a first opening O1. The first opening O1 is connected to the first accommodation space S1. The first battery assembly 120 is fixed in the first accommodation space S1. Specifically, the first battery assembly 120 includes two first battery rows 121 and two first management circuitries 122. The two first battery rows 121 and the two first management circuitries 122 are located in the first accommodation space S1, and the two first management circuitries 122 are respectively stacked on the two first battery rows 121 via, for example, brackets (not shown). In addition, each first battery row 121, for example, includes a plurality of first batteries 1211, and the first batteries 1211 are, for example, lithium batteries, but the invention is not limited thereto.

In this embodiment, the first battery assembly 120 includes the two first battery rows 121, and each first battery row 121 includes twenty first batteries 1211, but the invention is not limited thereto; in some other embodiments, the first battery assembly may include only one first battery row, and this first battery row may include ten first batteries or first batteries of another quantity.

The second battery module 200 includes a second casing 210 and a second battery assembly 220. The second casing 210 has a second accommodation space S2 and a second opening O2. The second opening O2 is connected to the second accommodation space S2. The second battery assembly 220 is fixed in the second accommodation space S2. Specifically, the second battery assembly 220 includes two second battery rows 221 and two second management circuitries 222. The two second battery rows 221 and the two second management circuitries 222 are located in the second accommodation space S2, and the two second management circuitries 222 are respectively stacked on the two second battery rows 221 via, for example, brackets. The second casing 210 is mounted on the first casing 110, and the second opening O2 of the second casing 210 is aligned with the first opening O1 of the first casing 110, such that the first casing 110 and the second casing 210 together surround the first battery assembly 120 and the second battery assembly 220 therebetween. In addition, each second battery row 221, for example, includes a plurality of second batteries 2211, and the second batteries 2211 are, for example, lithium batteries, but the invention is not limited thereto.

In this embodiment, the total quantity of the first batteries 1211 of the two first battery rows 121 are equal to the total quantity of the second batteries 2211 of the two second battery rows 221, and both of them are forty, and the first battery module 100 and the second battery module 200 are symmetrical with each other.

In this embodiment, the second battery assembly 220 includes the two second battery rows 221, and each second battery row 221 includes twenty second batteries 2211, but the invention is not limited thereto; in some other embodiments, the second battery assembly may include only one second battery row, and this second battery row may include ten second batteries or second batteries of another quantity.

In this embodiment, each of the first casing 110 and the second casing 210 are, for example, made by deep drawing process, the first casing 110 is made of one single piece, and the second casing 210 is made of one single piece. The first casing 110 of one single piece includes a first cover plate 111, a first annular side plate 112, and a first annular tab plate 113. The first annular side plate 112 is connected to a periphery of the first cover plate 111, and an angle formed between the first annular side plate 112 and the first cover plate 111 is, for example, slightly greater than 90 degrees. The first annular tab plate 113 is connected to one side of the first annular side plate 112 located opposite to the first cover plate 111. Since the first cover plate 111, the first annular side plate 112, and the first annular tab plate 113 are integrally connected to one another, there is no need to weld the first cover plate 111, the first annular side plate 112, and the first annular tab plate 113. Therefore, the structural strength of the first casing 110 is increased, and the first casing 110 achieves the waterproof and dustproof effect of IP67. Similarly, the second casing 210 of one single piece includes a second cover plate 211, a second annular side plate 212, and a second annular tab plate 213. The second annular side plate 212 is connected to a periphery of the second cover plate 211, and an angle formed between the second annular side plate 212 and the second cover plate 211 is, for example, slightly greater than 90 degrees. The second annular tab plate 213 is connected to one side of the second annular side plate 212 located opposite to the second cover plate 211. Since the second cover plate 211, the second annular side plate 212, and the second annular tab plate 213 are integrally connected to one another, there is no need to weld the second cover plate 211, the second annular side plate 212, and the second annular tab plate 213. Therefore, the structural strength of the second casing 210 is increased, and the second casing 210 achieves the waterproof and dustproof effect of IP67.

In this embodiment, the first cover plate 111 and the first annular side plate 112 of the first casing 110 of one single piece may include at least one protrusion rib 1121, which increases the structural strength of the first casing 110. Similarly, the second cover plate 211 and the second annular side plate 212 of the second casing 210 of one single piece may include at least one protrusion rib 2121, which increases the structural strength of the second casing 210.

Moreover, the first casing 110 and the second casing 210 can be produced by the same mold, such that the first casing 110 and the second casing 210 are the same in shape and size so as to be symmetrical with each other, thereby reducing the cost in producing the first casing 110 and the second casing 210.

Furthermore, since the first casing 110 and the second casing 210 are symmetrical with each other, the height of the first casing 110 and the height of the second casing 210 may be approximately equal to a half of the overall height of the power supply device 10, such that the structure strengths of the first casing 110 and the second casing 210 can be increased, and the first casing 110 and the second casing 210 can achieve the waterproof and dustproof effect of IP67.

In addition, the first battery assembly 120 and the second battery assembly 220 are respectively and symmetrically mounted in the first casing 110 and the second casing 210, the combination of the first casing 110 and the first battery assembly 120 can increase the overall structural strength of the first battery module 100, and the combination of the second casing 210 and the second battery assembly 220 can increase the overall structural strength of the second battery module 200.

In this embodiment, the power supply device 10 may further include a sealing pad 300. The sealing pad 300 is located between and clamped by the first annular tab plate 113 and the second annular tab plate 213, such that the sealing pad 300 can improve the waterproof and dustproof effect.

According to the power supply device as discussed in the above embodiment, since the first casing of one single piece and the second casing of one single piece are symmetrical with each other and are the same in shape and size, the height of the first casing and the height of the second casing may be approximately equal to a half of the overall height of the power supply device, such that the structure strengths of the first casing and the second casing can be increased, and the first casing and the second casing can achieve the waterproof and dustproof effect of IP67.

In addition, the first battery assembly and the second battery assembly are respectively and symmetrically mounted in the first casing and the second casing, the combination of the first casing and the first battery assembly can increase the overall structural strength of the first battery module, and the combination of the second casing and the second battery assembly can increase the overall structural strength of the second battery module.

In this embodiment of the invention, the power supply device may be applied in vehicle field, such as self-driving vehicle, electric vehicle, or semi-self-driving vehicle.

It will be apparent to those skilled in the art that various modifications and variations can be made to the present invention. It is intended that the specification and examples be considered as exemplary embodiments only, with a scope of the invention being indicated by the following claims and their equivalents.

What is claimed is:

1. A power supply device, comprising:
a first battery module, comprising:
a first casing, having a first accommodation space and a first opening, wherein the first opening is connected to the first accommodation space; and
a first battery assembly, fixed in the first accommodation space; and
a second battery module, comprising:
a second casing, having a second accommodation space and a second opening, wherein the second opening is connected to the second accommodation space; and
a second battery assembly, fixed in the second accommodation space;
wherein the first casing is mounted on the second casing, each of the first casing and the second casing is made of one single piece, and the first casing and the second casing are the same in shape and size.

2. The power supply device according to claim 1, wherein the first battery module and the second battery module are symmetrical with each other.

3. The power supply device according to claim 1, wherein the first battery assembly comprises at least one first battery row and at least one first management circuitry, the at least one first battery row and the at least one first management circuitry are located in the first accommodation space, and the at least one first management circuitry is stacked on the at least one first battery row.

4. The power supply device according to claim 3, wherein the second battery assembly comprises at least one second battery row and at least one second management circuitry, the at least one second battery row and the at least one second management circuitry are located in the second accommodation space, and the at least one second management circuitry is stacked on the at least one second battery row.

5. The power supply device according to claim 4, wherein the at least one first battery row comprises two first battery rows, the at least one second battery row comprises two second battery rows, the at least one first management circuitry comprises two first management circuitries, and the at least one second management circuitry comprises two second management circuitries, the two first management circuitries are respectively stacked on the two first battery rows, and the two second management circuitries are respectively stacked on the two second battery rows.

6. The power supply device according to claim 5, wherein each of the two first battery rows comprises a plurality of first batteries, each of the two second battery rows comprises a plurality of second batteries, and a total quantity of the plurality of first batteries of the two first battery rows is equal to a total quantity of the plurality of second batteries of the two second battery rows.

7. The power supply device according to claim 1, wherein the first casing and the second casing are made by deep drawing process.

8. The power supply device according to claim 1, wherein the first casing comprises a first cover plate, a first annular side plate, and a first annular tab plate, the first annular side plate is connected to a periphery of the first cover plate, the first annular tab plate is connected to one side of the first annular side plate located opposite to the first cover plate, the second casing comprises a second cover plate, a second annular side plate, and a second annular tab plate, the second annular side plate is connected to a periphery of the second cover plate, the second annular tab plate is connected to one side of the second annular side plate located opposite to the second cover plate, and the second annular tab plate is mounted on the first annular tab plate.

9. The power supply device according to claim 8, further comprising a sealing pad, wherein the sealing pad is located between and clamped by the first annular tab plate and the second annular tab plate.

10. The power supply device according to claim 8, wherein an angle formed between the first annular side plate and the first cover plate is greater than 90 degrees, and an angle formed between the second annular side plate and the second cover plate is greater than 90 degrees.
